(19) United States
(12) Patent Application Publication
(10) Pub. No.: US 2006/0020655 A1
(43) Pub. Date: Jan. 26, 2006

(54) Library of low-cost low-power and high-performance multipliers

(75) Inventor: Rong Lin, Geneseo, NY (US)

Correspondence Address: DILWORTH & BARRESE, LLP, 333 EARLE OVINGTON BLVD., UNIONDALE, NY, 11553, US

(73) Assignee: The Research Foundation of State University of New York, Albany, NY (US)

(21) Appl. No.: 11/170,417

(22) Filed: Jun. 29, 2005

Related U.S. Application Data
(60) Provisional application No. 60/583,948, filed on Jun. 29, 2004.

(51) Int. Cl. G06F 7/52

(52) U.S. Cl. 708/620

(57) ABSTRACT

Disclosed is an apparatus and method for producing a library of low-cost, low-power multipliers which are easy to build, have self testing capabilities, and are regular. The multipliers multiply a first word having N bits by a second word having M bits and include a plurality of smaller multipliers each including a single array of borrow parallel counters for receiving a trisected input and processing at least part of a trisected input according to a predetermined formula, an x:2 (where x=3, 2) counter which may be coupled with at least one borrow parallel counter to form a synthesized borrow parallel counter, and an adder coupled to an output of at least one of the borrow parallel counters, the adder for summing the output of the at least one borrow parallel adder. Each of the smaller multipliers receives a trisected input and an adder for receiving and summing the outputs of the smaller multipliers.

### PRIORITY

The present application claims priority to a provisional patent application entitled “A LIBRARY OF LOW-COST LOW-POWER AND HIGH-PERFORMANCE MULTIPLIERS,” filed on Jun. 29, 2004, and assigned Ser. No. 60/583,948, the contents of which are hereby incorporated by reference.

### STATEMENT OF GOVERNMENT INTEREST

The present invention was funded, at least in part, by NSF Grant CCR 0073469, Computer Systems Architecture, July 2000 to May 2003. The government has certain rights in the present invention.

### BACKGROUND OF THE INVENTION

1. Field of the Invention

The present invention relates generally to low power high-performance digital circuits and in particular, to highly complexity-effective multiplier triple expansion schemes enabling the construction of a large library of NxN multipliers with input size N ranging from 3 to 99 bits.

2. Description of the Related Art

Conventional multiplier schemes, including the state-of-the-art approaches (see, R. Montoye et al., “A Double Precision Floating Point Multiplier,” Proc. of 2003 IEEE ISSCC, February, 2003, and N. Itoh et al., “A 600 MHz, 54×54-bit Multiplier With Rectangular styled Wallace Tree”, IEEE JSSCs, Vol. 35, No. 2, February 2001), which produce high-speed, low-power circuits, are usually not feasible for use in the construction of a large library of multipliers. This is because expansive custom design and mask work are required because of the large amount of irregular circuits involved to construct these circuits. Consequently, existing Application Specific Integrated Circuit (ASIC) flexible design-tool libraries lack sufficient capabilities for building a large library of multipliers.

Moreover, conventional large multiplier circuits are typically constructed based on the schemes of generation of a single or a few large irregular bit matrices, followed by several stages of reduction of the bits into two numbers using binary-logic. However, these circuits are ineffective in dealing with the irregularity. Accordingly, in order to achieve high-performance level, these multiplier circuits usually require an increased amount of circuit complexity. This increase in circuit complexity not only adds to the multiplier circuit's design and testing time, but also increases design, optimization and manufacturing costs.

Thus, there is a need for borrow parallel counter circuits and highly complexity-effective multiplier triple expansion schemes which can enable the construction of a large library of NxN multipliers with input size N ranging from 3 to 99 bits with minimal cost, effort and complexity.

### SUMMARY OF THE INVENTION

It is, therefore, an object of the present invention to provide borrow parallel counter circuits and highly complexity-effective multiplier triple expansion schemes which enable the construction of a large library of NxN multipliers with input size N ranging from 3 to 99 bits with minimal cost, effort and complexity.

It is a further object of the present invention to provide low-cost, compact low-power high-performance multipliers, particularly for a library of different sizes of multipliers including small (e.g., 3 to 11 bits), medium (e.g., 12 to 33 bits), and large (e.g., 34 to 99 bits) multipliers, corresponding unique schemes and circuits.

It is a further object of the present invention to provide a library which can be used as a flexible design tool for Designing Application Specific Integrated Circuits (ASIC's).

The novel borrow parallel counter circuits and highly complexity-effective multiplier triple expansion schemes proposed by the present invention enable the construction of a large library of NxN multipliers with an input size N which is preferably between 3 and 99 bits, with low cost and complexity.

High Performance Multiplier Circuits and Triple Expansion Schemes are described in R. Lin and R. B. Alonzo, “A Library Of Low-Cost High-Performance Multipliers Using Borrow Parallel Counters And Double-Triple Expansion Schemes,” Proc. Of Workshop On Unique Chips And Systems” (UCAS-1), March, 2005, Austin, Tex., pp. 74-83. R. Lin and R. B. Alonzo, “An Extra-Regular, Compact, Low-Power Multiplier Design Using Triple-Expansion Schemes And Borrow Parallel Counter Circuits,” Proc. of workshop on complexity-effective design (WCED, ISCA), June 2003, the contents of which are incorporated herein by reference.

### BRIEF DESCRIPTION OF THE DRAWINGS

The foregoing and other objects, aspects, and advantages of the present invention will be better understood from the following detailed description of preferred embodiments of the invention with reference to the accompanying drawings, in which:

FIG. 1A is block diagram illustrating an extra-compact, low-power, high-speed, CMOS circuits 5_1 borrow parallel counter (hereinafter a 5_1 counter), serving as building blocks for parallel arithmetic designs;

FIG. 1B is a detailed block diagram illustrating circuitry which can be substituted in the 5_1 counter of FIG. 1 to create a 5_1_1 borrow parallel counter (hereinafter a 5_1_1 counter);

FIGS. 1C and 1D are detailed block diagrams illustrating the 5_1 and 5_1_1 borrow parallel counters of FIGS. 1A and 1B;

FIG. 2A is a block diagram illustrating a first base multiplier included in a small multiplier sub-library;

FIG. 2B is a block diagram illustrating a second base multiplier included in the small multiplier library;

FIGS. 2C-2E are diagrams illustrating a 6_0, non-full counter, a 6_1, full counter, and a 7_0, full counter, respectively;

FIGS. 3A-3C are diagrams illustrating multiplier triple expansion schemes;

FIG. 4 is a diagram illustrating a Level-1 multiplier triple expansion scheme;

FIG. 5 is a diagram illustrating a Level-2 multiplier triple expansion scheme;

FIG. 6 is a diagram illustrating 2:2 and 3:2 binary counters and their corresponding symbols;

FIG. 7 is a diagram illustrating a 6-b high-speed and compact ripple-carry adder SA6;

FIGS. 8A-8C is are diagrams illustrating a modification of a 3m−b (m=6) multiplier into a (3m+1)−b multiplier and a (3m−1)−b multiplier, respectively;

FIGS. 9A and 9B are diagrams illustrating a partial product matrix of an mxm multiplier (where m=4);

FIGS. 10A and 10B are diagrams illustrating Carry-look-ahead binary counters 3:2L and 3:2NL, and their corresponding symbols;

FIGS. 11A-11C are diagrams illustrating the circuitry of a 6SA8 Carry-look-ahead-adder; the structural symbol which indicates a 4-b ripple adder followed by a 2-b carry-look-ahead node and then followed by a 2-b ripple adder; and the abstract symbol which means the small 8-b adder has a critical path including 6 transmission gates (or pass transistors), respectively;

FIG. 12 is a diagram illustrating a Carry-look-ahead-adder 6SA9;

FIGS. 13A-13C are diagrams illustrating a Carry-look-ahead-adder's 6SA10 circuit; the structural symbol which indicates a 3-b ripple adder followed by a 2-b carry-look-ahead node and then followed by a 3-b carry-look-ahead node then a 2-b ripple adder; and the abstract symbol which means the small 10-b adder has a critical path including 6 transmission gates, respectively;

FIG. 14 is a diagram illustrating a Carry-look-ahead-adder 7SA12;

FIG. 15 is a diagram illustrating a Carry-look-ahead-adder 8SA15;

FIG. 16 is a diagram illustrating a Carry-look-ahead-adder 8SA17;

FIG. 17 is a diagram of small adders with 1-level Carry-look-ahead nodes: (a) 4SA6 (for 6×6-6); (b) 5SA8 (for 7×7-8); (c) 6SA10 (for 8×8-10) (d) 6SA10 (e) 6SA11 (f) 7SA13 (for 9×9-12) (g) 7SA14 (h) 8SA15 (for 10×10-b-15) (i) 8S16(j) 8SA16 (k) 8SA17 (for 11×11-b-17);

FIG. 18 is a diagram illustrating a medium-size 24-b adder for the final addition of an 18×18 multiplier with 2-level look-ahead nodes;

FIG. 19 is a diagram illustrating a medium-size 54-b adder for the final addition of a 33×33 multiplier with a 3-level look-ahead nodes, in which the carry-look-ahead structure is shown in horizontal (right to left for LSB to MSB), which is the same as that shown in vertical form as shown in FIGS. 11b, 17, and 17e (for 6SA11);

FIG. 20 is a diagram illustrating a large-size 89-b adder for the final addition of a 54×54 multiplier with 3-level look-ahead nodes;

FIG. 21 is a diagram illustrating a multiplier redistributing a few (e.g., 10 as shown) partial product bits for (3m+1)×(3m+1) multipliers (where m=5);

FIG. 22 is a diagram illustrating a multiplier redistributing and zeroing several (e.g., 6) partial product bits for (3m−1)×(3m−1) multipliers (where m=4);

FIG. 23 is a diagram illustrating an input distribution and circuit structure of level-1 carry-save-adder (CSA) of an 18×18 multiplier;

FIG. 24 is a diagram illustrating an input distribution and circuit structure of a level-1 carry-save adder (CSA) of a 19×19 multiplier which is modified from the 18×18 multiplier shown in FIG. 23;

FIG. 25 is a diagram illustrating an input distribution and circuit structure of level-1 CSA of 17×17 multiplier modified from FIG. 23;

FIG. 26 is a diagram illustrating three types of segmented small adders: type-8, type-9, type-10;

FIG. 27 is a diagram illustrating an organization of nine 18×18-b virtual multipliers;

FIG. 28 is a diagram illustrating outputs from nine 18×18 virtual multipliers to a level-2 CSA counter array of a 54-b multiplier, where level-2 contains an array of borrow parallel counters which is similar to a level-1 CSA but larger;

FIG. 29 is a diagram illustrating five types of segmented small adders: type-6, type-7, type-8, type-9, type-10;

FIG. 30 is a diagram illustrating an organization of nine 21×21-b virtual multipliers;

FIG. 31 is a diagram illustrating outputs generated from nine 21×21 virtual multipliers (i.e., from segmented small adders);

FIG. 32 is a diagram illustrating outputs from nine 21×21 virtual multipliers to a level-2 CSA counter array of the 63-b multiplier;

FIG. 33 is a diagram illustrating three types of segmented small adders: type-8, type-9, type-10;

FIG. 34 is a diagram illustrating an organization of nine 24×24-b virtual multipliers;

FIG. 35 is a diagram illustrating outputs generated from nine 24×24 virtual multipliers (i.e., from segmented small adders);

FIG. 36 is a diagram illustrating outputs from nine 24×24 virtual multipliers to a level-2 CSA counter array of a 72-b multiplier inputs to CSA of Level-2;

FIG. 37 is a diagram illustrating three types of segmented small adders: type-9, type-10, type-11;

FIG. 38 is a diagram illustrating an organization of nine 33×33-b virtual multipliers;

FIG. 39 is a diagram illustrating outputs from the nine 33×33 virtual multipliers to a level-2 CSA counter array of a 99-b multiplier inputs to CSA of Level-2;

FIG. 40 is a diagram illustrating a 5_1′ borrow parallel counter (5_1 with an extra hidden constant input 1);

FIG. 41 is a diagram illustrating 4×4-b twos complement multipliers, in which a circle followed by an arrow indicates a hidden bit (see FIG. 9);

FIG. 42 is a diagram illustrating 5×5-b twos complement multipliers, in which a circle followed by an arrow indicates a hidden bit (see FIG. 9);

FIG. 43 is a diagram illustrating a 6×6-b twos complement multipliers, in which only one 5_1 borrow counter in column 6 is replaced by a 5_1′ counter in this modification;

FIG. 44 is a diagram illustrating 7×7-b twos complement multipliers, in which only one 6_0 borrow counter in column 7 is replaced by a 6_0′ counter in this modification;

FIG. 45 is a diagram illustrating 8×8-b twos complement multipliers, in which only one 6_0 borrow counter in column 8 is replaced by a 6_0′ counter in this modification;

FIG. 46 is a diagram illustrating 9×9-b twos complement multipliers, in which only one 6_0 borrow counter in column 9 is replaced by a 6_0′ counter in this modification;

FIG. 47 is a diagram illustrating 10×10-b twos complement multipliers, in which only one 6_0 borrow counter in column 10 is replaced by a 6_0′ counter in this modification; and

FIG. 48 is a diagram illustrating 10×10-b twos complement multipliers, in which only one 7_0 borrow counter in column 11 is replaced by a 7_0′ counter in this modification.

### DETAILED DESCRIPTION OF THE PRESENT INVENTION

The novel borrow parallel counter circuits and highly complexity-effective multiplier triple expansion schemes according to the present invention enable the construction of a large library of NxN multipliers with input size N ranging from 3 to 99 bits with minimal cost and effort.

The present invention provides for low-cost, compact, low-power high-performance multipliers, particularly for a library of different sizes of multipliers including small (e.g., 3 to 11 bits), medium (e.g., 12 to 33 bits), and large (e.g., 34 to 99 bits) multipliers, and unique schemes and circuits for these multipliers.

A description of the multiplier design, the borrow parallel multiplier library, and the library components will be given below.

The present invention provides a scheme to produce complexity-effective, high-speed, low-power, NxN-b multipliers, where N preferably is an positive integer between 3 and 99. Moreover, the present invention enables large multipliers to be generated from smaller multipliers using a unified expansion scheme. Typically, the size of a resulting multiplier is almost tripled in two or fewer steps. A sub-library including nine extra-regularly structured base multipliers (e.g., 3-b to 11-b multipliers) is designed and optimized, which significantly simplifies the library construction. For example, with 6-b base multipliers, an 18-b multiplier is constructed in a first step, and the resulting 18-b multiplier is then used to construct a 54-b, Institute of Electrical and Electronics Engineers (IEEE) standard floating point multiplier in a second step. In a similar fashion, with 7-b and 8-b base multipliers, 21-b and 22-b multipliers are constructed in a first step, and the 21-b or the 22-b multipliers can then be used to construct a 64-b multiplier.

The present invention employs both building block circuits (building blocks) and construction schemes, which optimize decompositions and minimize global complexity. The building blocks include a small library of nine base multipliers, each using complementary metal oxide semiconductors (CMOS), large parallel counters including “4-bit 1-hot” logic processing (where 4-bit 1-hot logic processing refers to 4 parallel data paths having only one input (IN) logic high) and borrow-bits, i.e., bits weighted 2 (see R. Lin and R. B. Alonzo, “A Library of Low-Cost High-Performance Multipliers Using Borrow Parallel Counters and Double-Triple Expansion Schemes,” in Proc. of Workshop on Unique Chips and Systems (UCAS-1), March, 2005, pp 74-83, which is incorporated herein by reference). As used herein, unless context indicates otherwise, the term “bit-weight position” refers to a column of a partial product matrix, in which each bit is in the same binary position with respect to the final product. A higher bit-weight position refers to a column in a binary position with higher significance, e.g., in the 2^{4th} place, as compared to the 2^{3rd} place, and a lower bit-weight position refers to a column in a binary position with lower significance.

According to the present invention, the building block circuits are capable of rearranging and balancing input bits in each processing column, and turning irregular multiplication units (e.g., multipliers) into substantially regular single array structured small multipliers, thus greatly reducing the local complexity allocated to each block during the decomposition. This construction scheme optimizes the decomposition, resulting in a natural rectangular-shaped and simply wired structure, thereby effectively minimizing the global complexity.

According to the present invention, the overall multiplier construction is a highly regular, modular, one-level or two-level (recursive) process. The multiplier construction trisect-decomposes an input bit matrix and re-positions the partitioned blocks to achieve an optimal design/layout and to improve the self-testability.

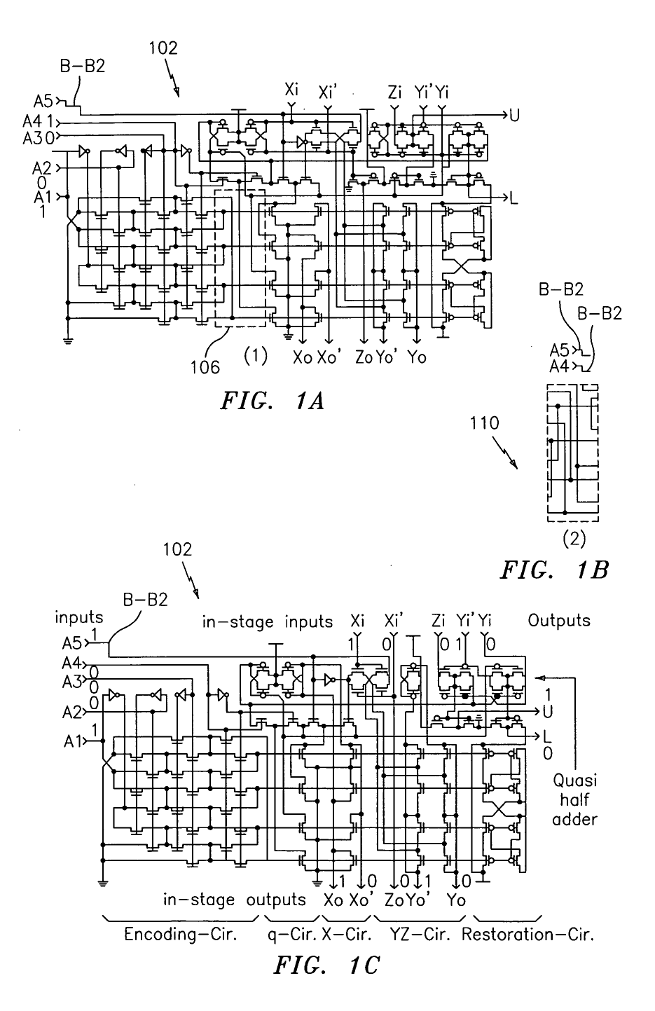

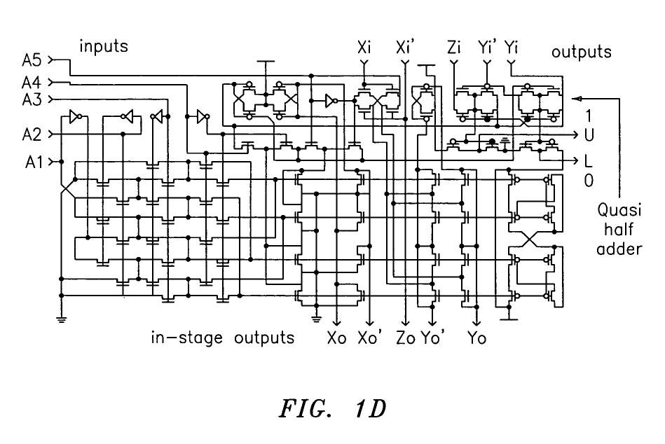

A block diagram illustrating a 5_1_1 borrow parallel counter (5_1 counter) according to the present invention is shown in FIG. 1A. The 5_1 counter 102 is a parallel counter which can serve as building block for parallel arithmetic designs. The 5_1 counter 102 has a regular distribution of cells and includes a “4-bit-1-hot” logic feature with a logic high and a “borrow bit” of weight 2 (i.e., B-B2). The 5_1 counter 102 includes 5 inputs (A₁-A₅), two outputs (U and L), and three pairs of in-stage input/output bits, X, Y, Z (with contiguous counters close to each other), where the weighted sum of all outputs equals the weighted sum of all inputs. This is more clearly illustrated with reference to Equation 1 below which corresponds to the 5_1 counter. In Equations 1 and 2 below, the variables on the left side of the equation are inputs and in-stage inputs and the variables on the right side of the equation are outputs and in-stage outputs. All variables in all equations are binary variables, and all operations are arithmetic operations except that OR, XOR, AND and prime sign′ (for complement) are logic operations.
A1+A2+A3+A4+2A5+2Xi+4(Yi+2Yi′Zi)=Xo+2Yo+4(Yo′Zo+L)+8U; where Zo=Xi Equation (1)

The circuitry contained in insert 106 can be replaced by the circuitry shown in FIG. 1B to form a 5_1_1 counter which will be described below.

A detailed block diagram illustrating circuitry which can be substituted in the 5_1 counter of FIG. 1A to create a 5_1_1 counter is shown in FIG. 1B. These counters are also known as borrow parallel counters. The 5_1_1 counter 110 is formed by replacing the circuitry in the insert 106 of the 5_1 counter 102 (FIG. 1A) with circuitry contained in insert 110. The 5_1_1 counter includes 5 inputs A₁-A₅, (with a difference being that bits A₄-A₅ are used as borrow bits), two outputs (U and L), and three pairs of in-stage input/output bits, X, Y, Z (with contiguous counters close to each other), where the weighted sum of all outputs equals the weighted sum of all inputs. This is more clearly illustrated with reference to Equation 2 below.
A1+A2+A3+2A4+2A5+2Xi+4(Yi+2Yi′Zi)=Xo+2Yo+4(Yo′Zo+L)+8U; where Zo=Xi Equation (2)

Detailed block diagrams illustrating the 5_1 and 5_1_1 borrow parallel counters of FIGS. 1A and 1B are shown in FIGS. 1C and 1D.

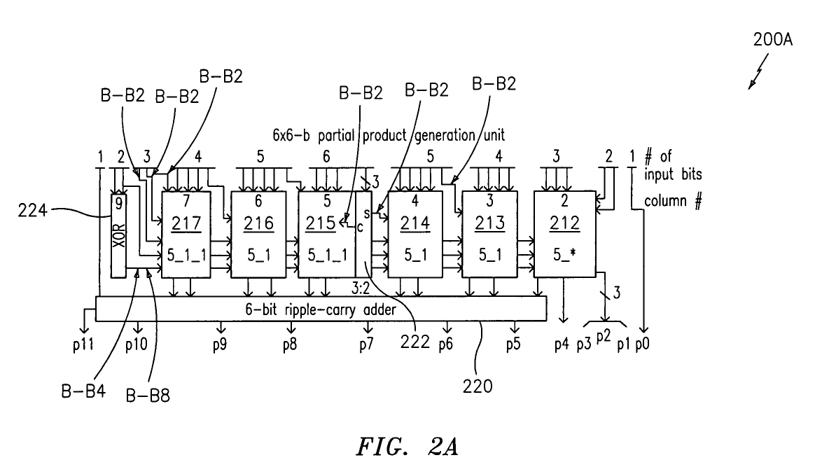

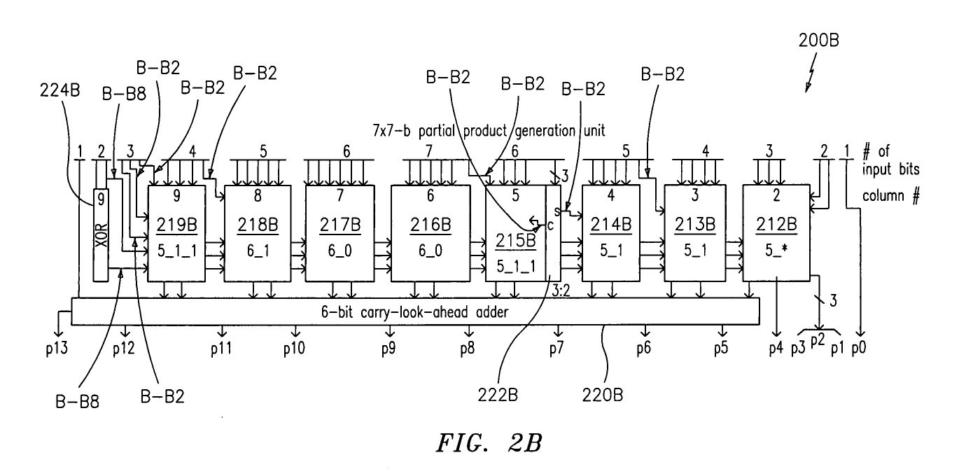

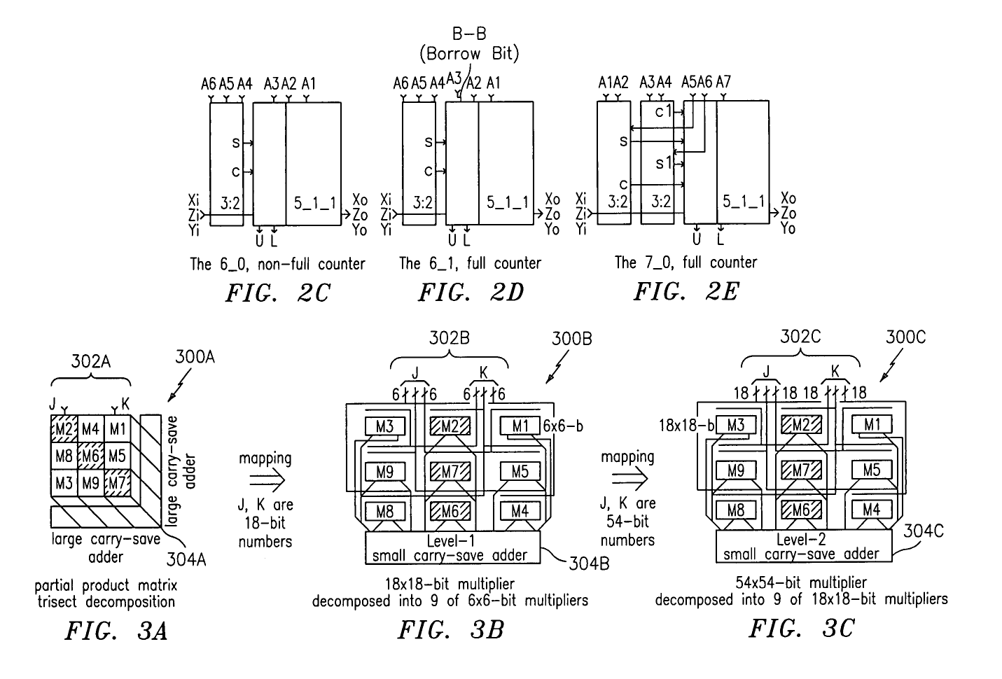

Three other borrow parallel counter variants are termed 6_0, 6_1 and 7_0 (not shown), and can be synthesized by the 5_1 or 5_1_1 circuits shown in FIGS. 1A and 2B, with the addition of one or two 3:2 counters (which is a type of x:2 counter). The 5_1, 5_1_1, 6_0, 6_1 and 7_0 counters each have a similar layout height which is approximately equal to a height of a 3:2 counter, but each counter differs in layout width. Moreover, the 5_1, 5_1_1, 6_0, 6_1 and 7_0 counters have speed differences which are not greater than the delay of a single 3:2 counter. The 6_0, 6_1 and 7_0 counters are illustrated in FIGS. 2C-2E, respectively.

Having the borrow bits each weighted 2 or more makes it possible to form small virtual (i.e., two numbers in output) multipliers (i.e., base multipliers), ranging from 3 to 11 bits each, in a structure having a single array of counters (e.g., see FIG. 2), with many desirable properties. These properties include having a perfectly rectangular shape (or substantially rectangular shape), substantially equal height, substantially equal delay, low power consumption, high speed, extra compact dimensions, and a simple CMOS construction.

When used as building blocks for the design and construction of larger multipliers (e.g., large multipliers with up to 99 bits), the base “virtual multipliers” turn irregular small multiplication units (e.g., the virtual and non-virtual multipliers having small and large sizes) into regular blocks of circuits, thus greatly reducing the local complexity of the large multipliers. The term “virtual multiplier” as used herein refers to a multiplier without the results of the final stage partial product reduction being added. The term “virtual product” as used herein refers to the results of the final stage partial product reduction of the virtual multiplier.

By adding a ripple-carry adder or a simple carry-look-ahead adder to each base virtual multiplier, the base multiplier sub-library is formed. The base multiplier sub-library will be described in further detail below with reference to FIGS. 2A-2B below.

A block diagram illustrating a first base multiplier included in a small-multiplier sub-library is shown in FIG. 2A. The first base multiplier 200A (also known as a 6×6-b partial product generation unit) includes a plurality of parallel base virtual multipliers 212-217, a 3:2 counter 222, and an XOR (exclusive or) gate 224. The base virtual multipliers 212-217 correspond to major columns 2 through 7, respectively, where the columns refer to corresponding columns of the partial product matrix of the 6×6 base multiplier. In the following example, the matrix has 11 columns 0 to 10, with columns 0, 1 and 8, 9, 10 degraded, and as such are not counted as major columns. The XOR gate 224 (which corresponds to column 9) inputs 2 bits as shown and outputs a result to the base virtual multiplier 217. A 3:2 counter 222 is coupled to the base virtual multiplier 215. The 3:2 counter sums input bits a, b, and c and outputs a two bit result s and c so that a+b+c=2c+s. The base virtual multipliers 213, 214, and 216 are 5_1 multipliers and the base virtual multipliers 215 and 217 are 5_1_1 multipliers.

Additionally, the base virtual multiplier 212 can be either a 5_1 or a 5_1_1 multiplier. Each of the base virtual multipliers 212-217 receives a given number of input bits as shown in FIG. 2A.

Borrow bits of weight 2 are denoted by B-B2, borrow bits of weight 4 (for Yi) are denoted by B-B4 and borrow bits of weight 8 (for Zi) are denoted by B-B8 and outputs a result. Each of the base virtual multipliers 212-217 operates as described above with reference to FIGS. 1A and 1B, and therefore, for the sake of clarity, no further description will be given. Borrow bits B-Bs, shown in offset, rearrange and balance inputs to each column so that only one of nearly identical base virtual counters 212-217 is needed in each column 0-9. The outputs of base virtual multipliers 212-217 are input into a 6-bit ripple-carry adder 220 which outputs bits P₅ to P₁₃, of a partial product P₀₋₁₃, which is the output of the first base multiplier 200A. The simple structures eliminate almost all irregularity inherent in such arithmetic units, providing a perfect base for larger multiplier designs.

A block diagram illustrating a second base multiplier included in a small-multiplier sub-library is shown in FIG. 2B. The second base multiplier 200B (also known as a 7×7-b partial product generation unit) is similar to the first base multiplier, with a difference being the substitution of an 8-bit carry-look ahead adder instead of a 6 bit ripple-carry adder which is used in the first base multiplier 200. The second base multiplier 200B includes a plurality of parallel base virtual multipliers 212B-219B, a 3:2 counter 222B, and an XOR (exclusive or) gate 224B.

The base virtual multipliers 212B-219B correspond to columns 2 through 9 (of the partial product matrix of the 6×6-b multiplier), respectively. The XOR gate 224B (which corresponds to column 9) inputs 2 bits as shown and outputs a result to the base virtual multiplier 217B. A 3:2 counter 222B is coupled to the base virtual multiplier 215B. The base virtual multipliers 212B is a 5_* multiplier, 213B and 214B are 5_1 multipliers, the base multipliers 215B and 219B are 5_1_1 multipliers, the base multipliers 216B and 217B are 6_1 multipliers, and the base multiplier 218B is a 6_1 multiplier. Each of the base virtual multipliers 212B-219B receives a given number of input bits as shown in FIG. 2B, and outputs a result. Each of the base virtual multipliers 212B-219B operates as described above with reference to FIGS. 1A and 1B, and therefore, for the sake of clarity, no further description will be given. Borrow bits B-Bs, shown in offset, rearrange and balance inputs to each column so that only one of the nearly identical base virtual counters 212B-219B is needed in each column 0-9. The outputs of base virtual multipliers 212B-219B are input into a 8-bit ripple-carry adder 220B, which outputs bits P₅ to P₁₃ of a partial product P₀₋₁₃, which is the output of the first base multiplier 200A.

For a more detailed description of base multipliers, see U.S. Patent Publication No. 2004/0172439 A1, entitled “Unified Multiplier Triple-Expansion Scheme And Extra Regular Compact Low-Power Implementations With Borrow Parallel Counter Circuits,” to R. Lin (the '439 Publication), the contents of which are incorporated by reference.

The other base multipliers belonging to the base multiplier library are similar to the first and second base multipliers described above and therefore, for the sake of clarity, are not shown.

According to the present invention, a triple expansion scheme optimizes the multiplier decomposition, resulting in naturally rectangular shapes and simple circuit wiring, thus effectively minimizing global complexity of the design of multipliers. The Simulations indicate that significant reductions can be achieved on overall design cost, power, and VLSI (very large scale integrated circuit) area, which is at least 25% smaller, and is much simpler than conventional multipliers. A comparison of multipliers according to the present invention with conventional multipliers is shown in Table 1 below.

TABLE 1

| | | area - scaled * | operation | | process * | self |
|---|---|---|---|---|---|---|
| multiplier | | relative value | frequency - tech | power | complexity | testable |
| 6-bit | borrow parallel | | 1 GHz-0.18 μm, 1.8 V | | | yes |
| | binary | 1836 μm² - 1 | 1 GHz-0.18 μm, 1.8 V | 0.83 μW | high | yes |
| 54-bit | triple expanded | | | NA * | | |
| | rectangular styled | 0.98 mm² - 2 | 0.6 GHz-0.18 μm, 1.8 V | NA | high | no |
| | Wallace tree [7] | | | | | |
| | limited switch | 0.15 mm² - 1 | 2 GHz-0.13 μm, 1.2 V | 522 mW | high | no |
| | dynamic logic [8] | | | | | |

In Table 1, “area—scaled relative value” refers to a scaled-for-technology based on Montoye's teachings; “operation frequency-tech” refers to the operational frequencies; “power” refers to power consumption of the multiplier; “process complexity” refers to the complexity of the multiplier and takes into account the amount of custom design-layout necessary, the difficulty of implementing the technology and the cost to both design and implement; and “self testable” refers to the stability of the multiplier.

The triple expansion method optimizes only one column of a plurality of CSA block columns in a multiplier processing a plurality of bit inputs. The method provides a first level of application of a triple expansion scheme PxP, where P is (3 m+z1), m is an integer multiplier, and z1 is {0, 1, −1}; and when required expanding the first level of application according to a ExE, where E is (3P+z2) and z2 is {0, 1, −1}.

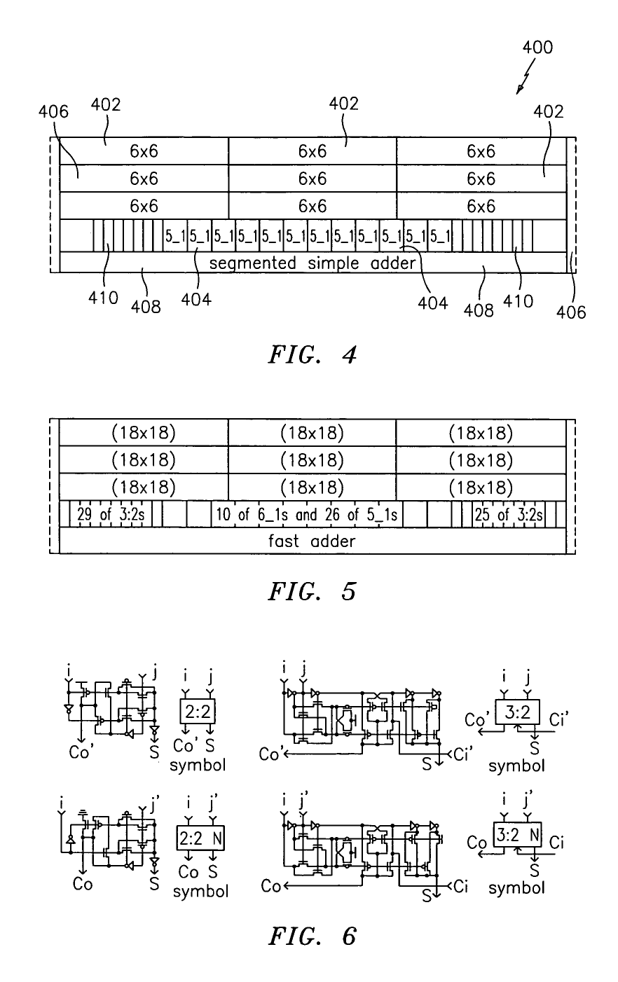

Efficient small multipliers of any magnitude may be considered as bases for the triple expansion to yield large multipliers. In an exemplary embodiment, the present invention has adopted two types of 6×6 and 7×7 multipliers shown in FIGS. 2A and 2B, respectively. The multipliers 200A and 200B of FIGS. 2A and 2B respectively are borrow parallel small multipliers, which use a single array of borrow parallel counters. The multiplier circuits will be described in detail below. Both multipliers receive two 6-bit input numbers, J and K generate a small partial product bit matrix, and then reduce it into two numbers P (p10-p0) and Q (q10-q5), so that J*K=P+Q*2**5. The (4,2)−(3,2) based 6×6 multiplier 150 of FIG. 4A uses slightly fewer transistors, while the borrow parallel 6×6 multiplier 152 of FIG. 4B has a more compact layout and mainly performs logic with 4b-1-hot signals that feature lower switching activity and use fewer hot lines.

Diagrams illustrating multiplier triple expansion schemes are shown in FIGS. 3A-3C. An MxM multiplier 300A is constructed using 9 smaller multipliers M1-M9 (e.g., 6×6-b multipliers) and large carry-save adder 304A. The multiplier's 300A inputs 302A include words J and K each having a given width (e.g., 6 bits). Using a trisect decomposition approach, the inputs J and K are trisected into input group-bits or six-bit segments, partitioned and distributed to the multipliers M1-M9. The multipliers M1-M9 then form partial product matrices (e.g., 6×6-b matrices) and 9 products (e.g., 12-b products) which are then input into the large carry-save adder 304A which computes a final product.

Multiplier 300B in FIG. 3B is a 18-18-b multiplier and has two 18-b inputs J and K and includes 9 6×6 multipliers M1B-M9B (whose connections are shown) which output their results to a Level-1 small carry-save adder 304B.

Multiplier 300C is a 54×54-b multiplier which is similar to the multipliers 300A and 300B shown in FIGS. 3A and 3B with the following differences. J and K are each 54-b inputs, multipliers M1C-M9C are each 18×18-b, and a Level-2 small carry save adder 304C is used to add the outputs of multipliers M1C-M9C.

A diagram illustrating a Level-1 multiplier triple expansion scheme is shown in FIG. 4. An 18×1 8-b virtual multiplier 400 includes nine 6×6-b multipliers 402, an array of counters including 5_1s 404 in the middle and 3:2s in each end 410 and a segmented simple adder 408. Note that by replacing the segmented simple adder with a carry-look-ahead adder, an 18×18 multiplier is obtained. To construct an NxN multiplier for some N(<34), one or two of the dotted areas 406 may be used for adder layout when necessary.

A diagram illustrating a Level-2 multiplier triple expansion scheme is shown in FIG. 5. A 54×54-b multiplier 500 includes nine 18×18-b multipliers 502 plus an array of counters including 5_1s and 6_1s 504 in the middle and 3:2s 510 in the ends, plus a carry look-ahead fast adder 508. Note that dotted areas 506 may be used for adder layout.

A diagram illustrating 2:2 and 3:2 binary counters and their corresponding symbols is shown in FIG. 6.

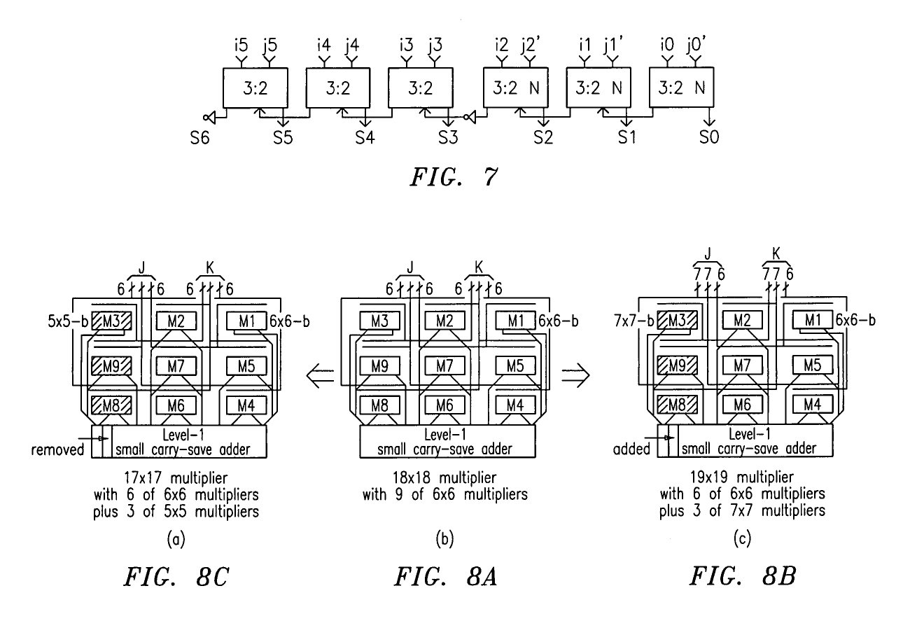

A diagram illustrating a 6-b high-speed and compact ripple-carry adder SA6 is shown in FIG. 7. The adder inputs (which are the outputs of bit a matrix reduction network or a CSA array, i.e., generated from the borrow parallel counters) and outputs bits S0-S6.

Diagrams illustrating a modification of a 3m-b (where m=6) multiplier into a (3 m+1)-b multiplier and a (3 m−1)-b multiplier are shown in FIGS. 8A-8C, respectively.

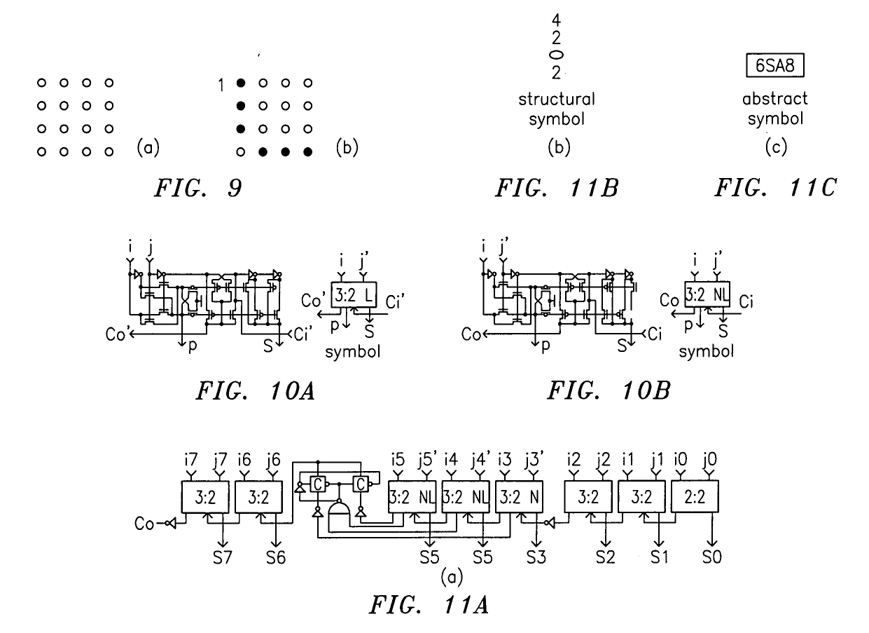

A diagram illustrating a partial product matrix of an mxm multiplier (where m=4) is shown in FIGS. 9A-9B. The original partial product matrix 900A is shown in FIG. 9A, and a modified matrix 900B is shown in FIG. 9B. The modified matrix 900B is a modified for 2's complement form inputs, and each solid circle represents the complement of an initially generated bit and a hidden-bit 1 is added on column m=4 (There are 7 columns from 0 to 6). For a more information see, C. R. Baugh and B. A. Wooley, “A Two's Complement Parallel Array Multiplication Algorithm,” IEEE Tran. on Computers, Vol. C-22, pp. 1045-1047, 1973.

The Multiplier Library

The multiplier library includes the following components:

(1) NxN Multipliers

Base Multipliers (3-b to 11-b Multipliers)

Each base multiplier includes :(a) an array of borrow parallel counters (including one or more optional 3:2 counters) which serves as a virtual base multiplier; and
(b) a ripple-carry or a single-level carry-look-ahead adder, which produces the final product (see FIGS. 2A and 2B).
   (2) Mid-Size Virtual Multipliers and Multipliers (12-b to 33-b Multipliers)

Each mid-size virtual multiplier includes:
(a) nine base multipliers of either the same type or no more than two different types (e.g., having 5_1 multipliers or a 5_1 and a 5_1_1 multipliers, etc.);
(b) an array of borrow parallel counters (including one or more 3:2 counters located in two end positions) which serves as a one-stage carry-save addition operator reducing no more than 5 input bits in each column into an output of two bits; and,
(c) a segmented ripple-carry or a single-level carry-look-ahead adder, i.e., an array of smaller adders, which produces the final product plus a few extra bits. Two short ripple-carry adders over lapped at one bit, which is an extra bit in designated columns so that no two extra bits will be produced in the same column when they reach to the next stage (e.g., see FIG. 4). This can be controlled by a simple location-related scheme. Each mid-size multiplier is the same as a mid-size virtual multiplier, except that its final adder is not segmented but is a one- or two-level carry-look-ahead final adder, which produces the final product.
   (3) Large-Size Multipliers (34-b to 99-b Multipliers)

Each large-size multiplier includes:
(a) nine midsize virtual multipliers of the same type or no more than two types;
(b) an array of borrow parallel counters (including one or more optional 3:2 counters in two end positions) which serves as a one-stage carry-save addition operator reducing no more than 6 input bits in each column into an output of two bits; and
(c) a three-level fast carry-look ahead final adder which produces the final product (e.g., see FIG. 5).
   (4) The Binary Counters and Adders

The present invention modifies the 2:2-3:2 counters which are disclosed in U.S. Patent Publication No. 2001/0,056,455, entitled “A Family Of High Performance Multipliers And Matrix Multipliers,” to R. Lin, which is incorporated herein by reference, to build the above multipliers with ripple carry adders (i.e., for triple expansion cases as opposed to double expansion cases.) (see FIG. 6). The binary counters and the constructed adders (see FIG. 7) include the following features:
(a) simple and compact, with a good layout that can well match a 5_1 counter layout;
(b) high speed on carry propagation;
(c) low power. A simulation has shown that each small adder or segmented adder used in the above library components has a delay comparable to a single 5_1 counter delay (about 650 ps with a 0.18 mm, 1.8 V technology).

The Modification of 3m-B Multipliers into (3 m+1)-B And (3 m−1)-B Multipliers

Each 3m-b multiplier can be modified to yield a (3 m+1)-b or a (3 m−1)-b. Very little modification is needed in layout for each of them. FIG. 8 illustrates the process briefly.

(1) The self-test programs Generic test programs exist. Due to the highly regular and modular structure, a test is partitioned into testing each borrow parallel counter and each 3:2 counter.

(2) 2's Complement NxN Multipliers

Each NxN multiplier can be modified easily to obtain a two's complement multiplier by introducing two borrow counter variants 5_1′ and 6_0′, which are the same as 5_1 and 6_0 counters except that each contains an extra hidden input 1 (e.g., a logic 1). Simulations show that the features of the modified circuits (e.g., inputs, circuits, layout, etc. other than the extra inputs which are equal to a logic 1) are the same as those of the original circuits. The scheme for this process is based on C. R. Baugh and B. A. Wooley, “A Two's Complement Parallel Array Multiplication Algorithm”, IEEE Tran. on Computers, Vol. C-22, pp. 1045-1047, 1973, which is incorporated herein by reference, and is as illustrated in FIGS. 9A and 9B.

(3) Pipelined Multipliers

Each NxN multiplier can also be modified easily to obtain a pipelined multiplier (more meaningfully for none-base N>11 multipliers). For a mid-size multiplier, four-stage pipelining may be used. Stages 1 and 2 are for the two steps of base multiplier operation, i.e., generating two numbers and then the product; Stages 3 and 4 are for level-1 CSA operation and the final addition. Each stage has about the same delay (less than 1 ns). For a large-size multiplier, six-stage pipelining may be used. Stages 1 to 3 are the same as those for a mid-size multiplier. Stage 4 generates a final product plus a few extra bits for each mid-size multiplier. Stages 5 and 6 are for level-2 CSA operation and the final addition. Each stage has about the same delay (less than 1 ns).

Other Detailed Library Components and Drawings

(1) Carry-Look-Ahead Adders

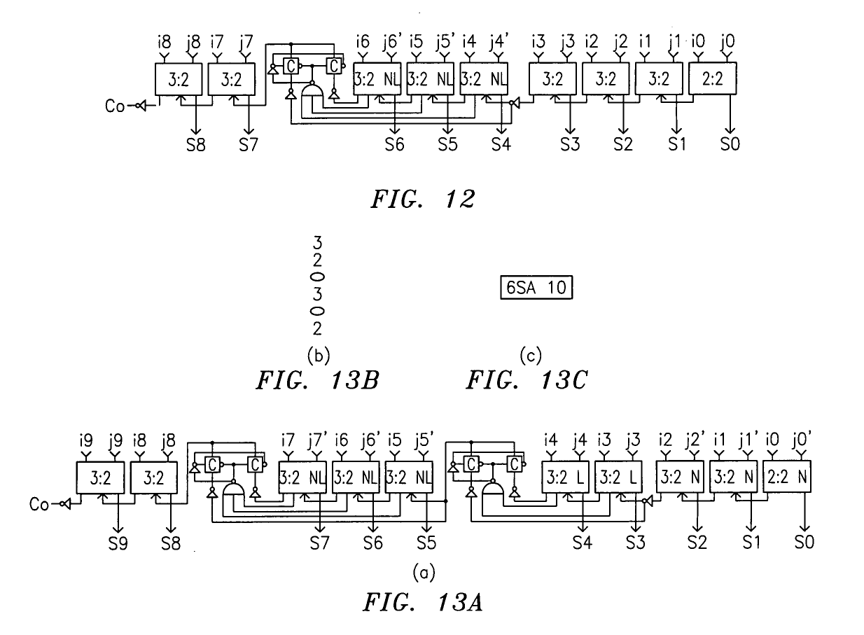

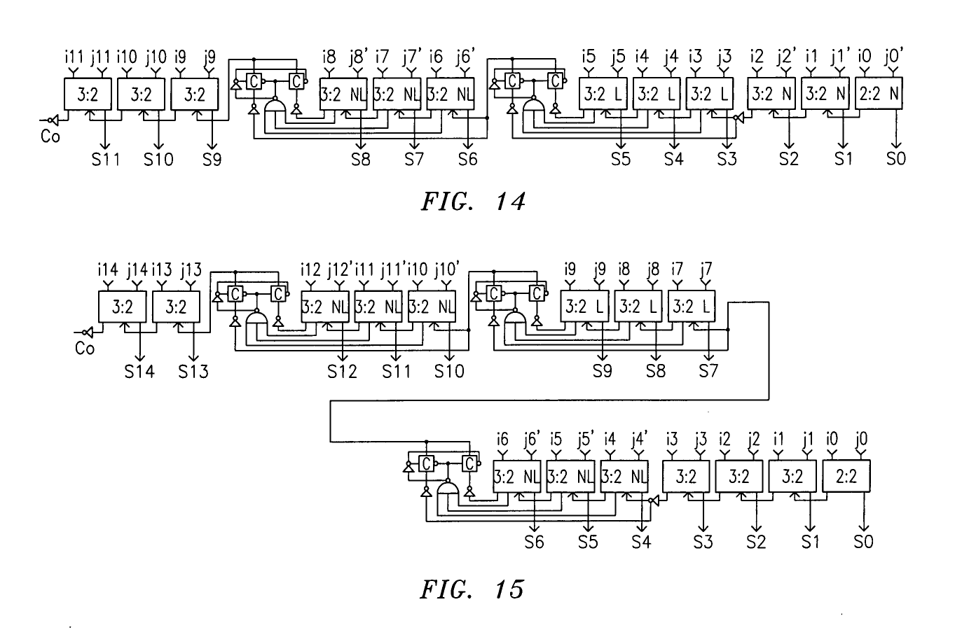

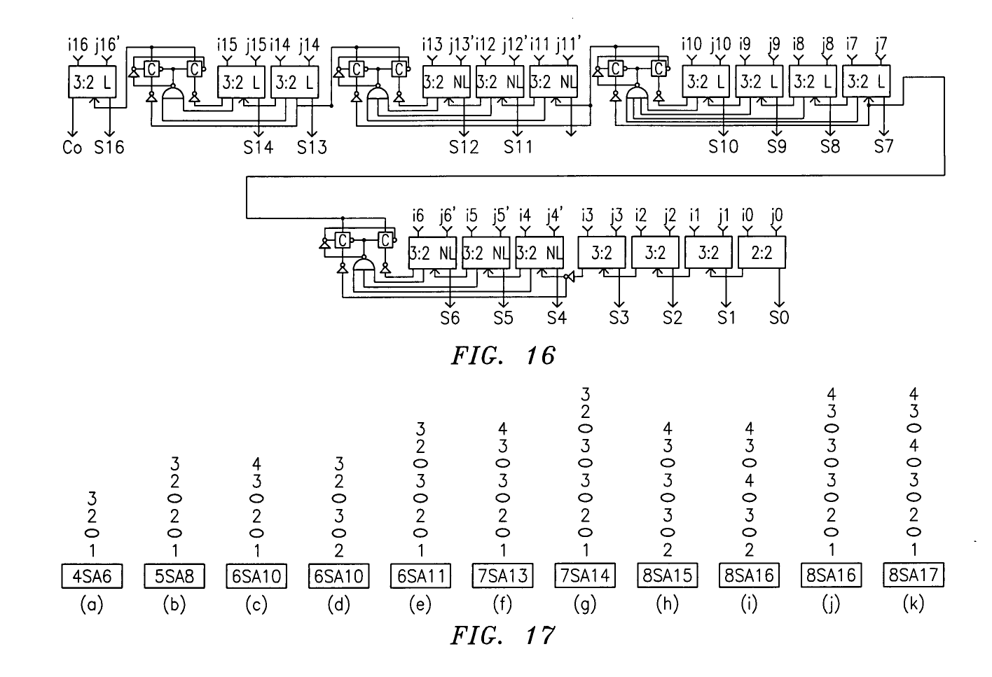

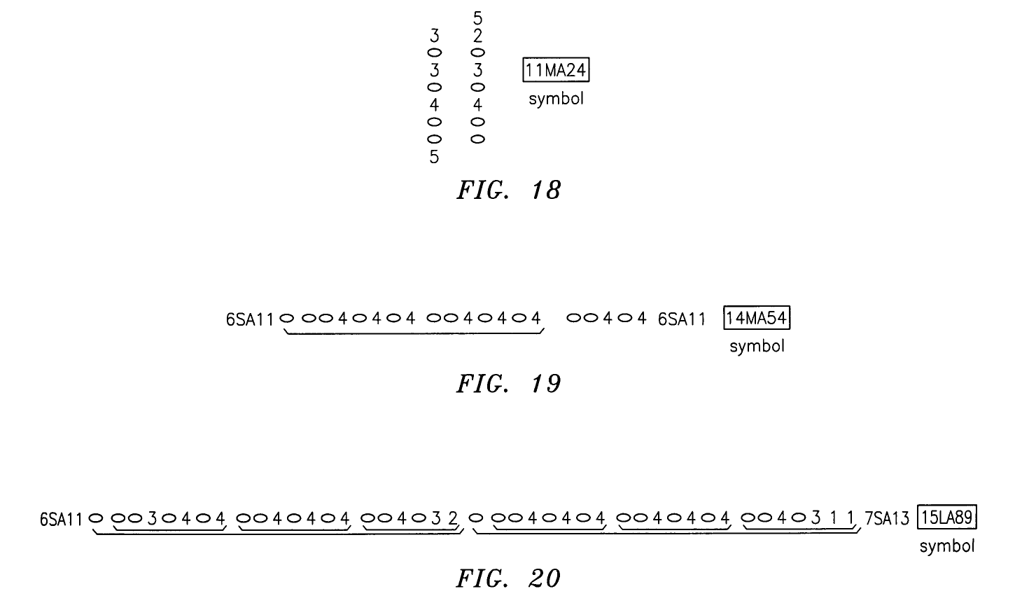

Modified tiny shift switch binary 2:2 and 3:2 counters (e.g., shown in FIG. 6) can be directly used (with an extra output bit p added) to construct carry-look-ahead adders as shown in FIGS. 10 to 20.

(2)The Modification of 3m-b Multipliers into (3 m+1)-b and (3 m−1)-b Multipliers

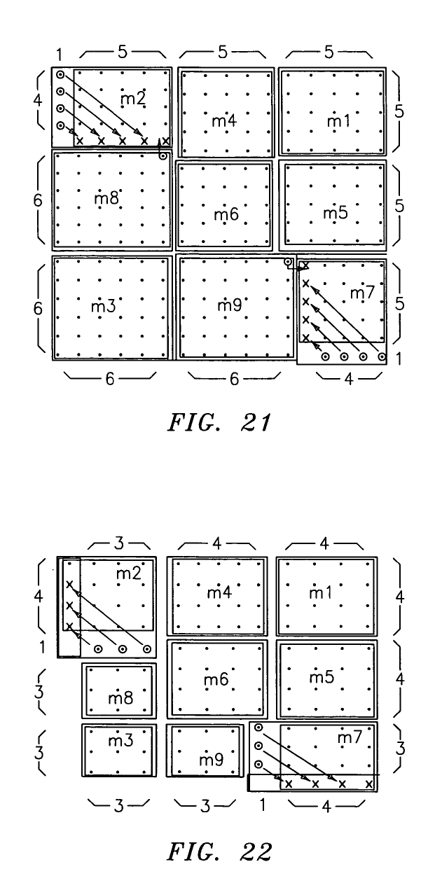

FIG. 21 illustrates the partial product bit matrix generated by two (3 m+1)-b numbers for m=5. With the indicated re-arrangement (as shown by the 10 arrows), there are nine square partial product matrices. Six of them are 5×5-b, and three of them are 6×6-b. Therefore, the process can be realized using hardware which is similar to that shown in FIG. 8A (note: sizes are slightly different). For a more detailed description of this rearrangement, see the '439 Publication.

FIG. 22 shows the partial product bit matrix generated by two (3 m−1)-b numbers for m=4. With the indicated re-arrangement (by 6 arrows plus 2 zero bits), there are nine square partial product matrices. Six of them are 4×4-b, and three of them are 5×5-b. Therefore, the process can be realized using hardware which is similar to that shown in FIG. 8C (note: sizes are also slightly different).

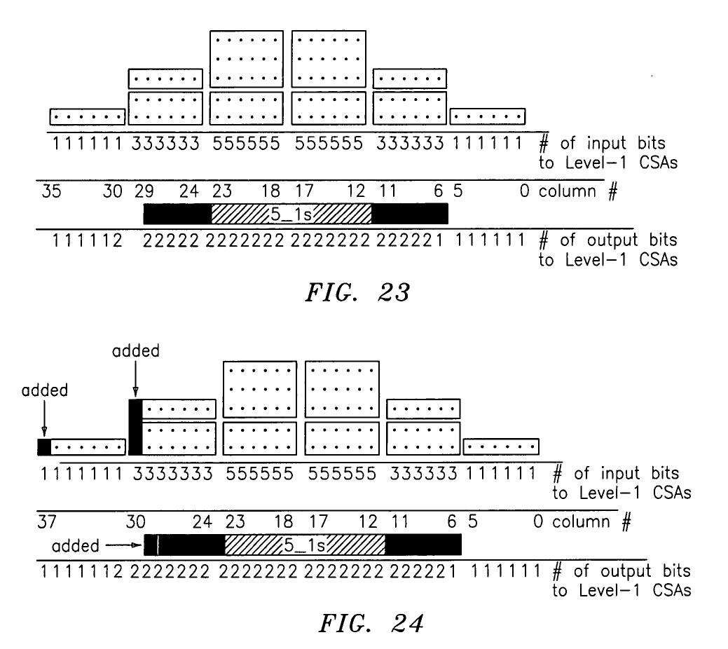

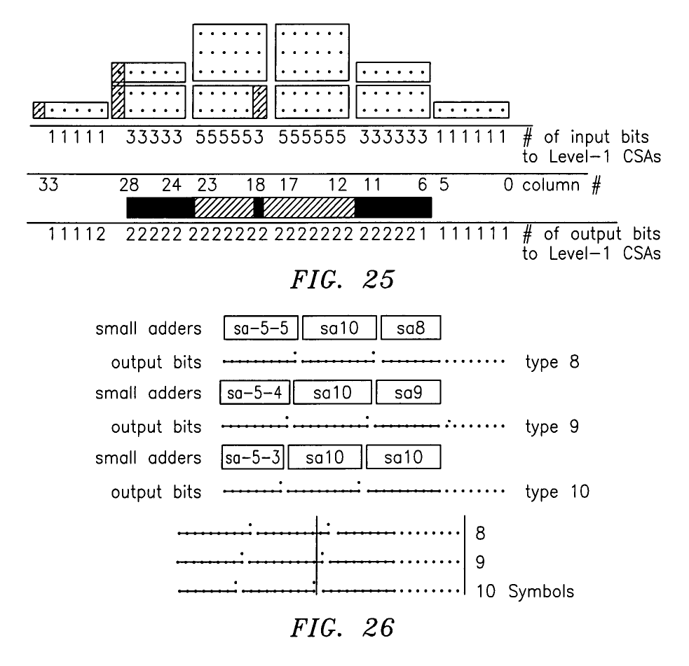

The CSAs modifications for the carry-save reduction are illustrated in FIGS. 23 to 25. FIG. 23 shows the 18×18 multiplier carry-save reduction. FIG. 24 shows the 19×19 barray-save reduction slightly modified from FIG. 23. FIG. 25 shows the 17×17 barray-save reduction slightly modified from FIG. 23.

(3)The Organization of Balanced Segmented Adders

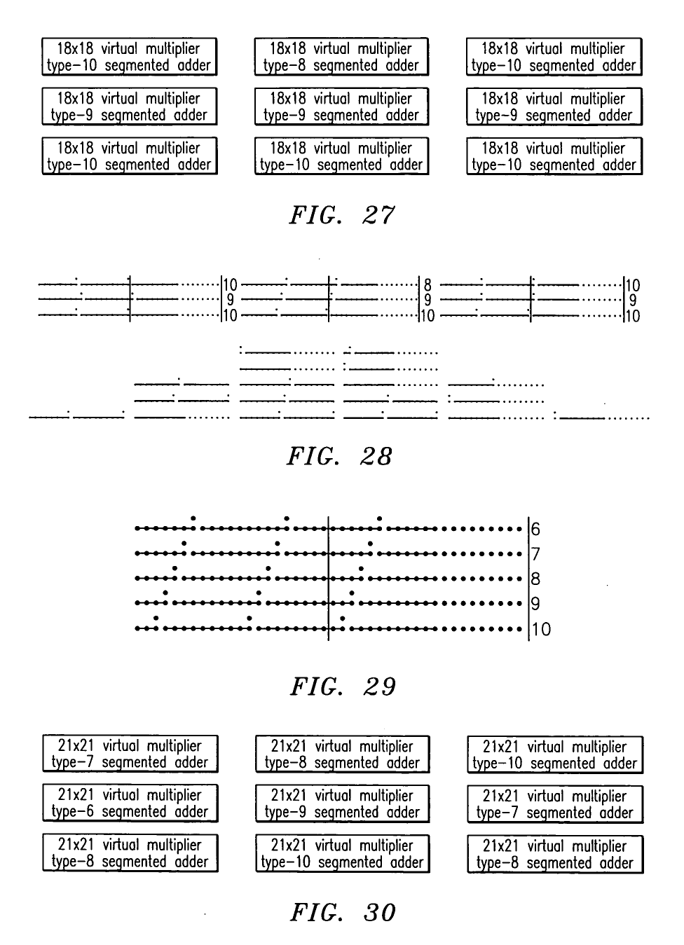

FIGS. 26 to 28 show a 54×54 multiplier;

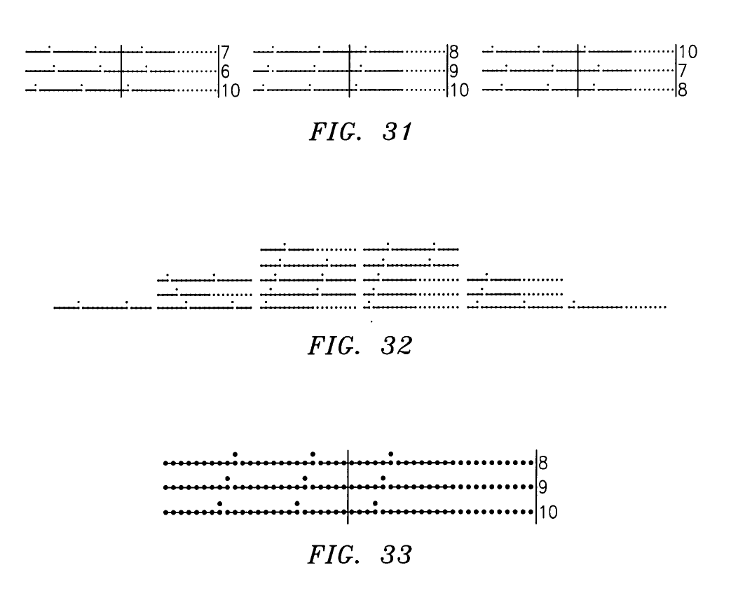

FIGS. 29 to 32 show a 63×63 multiplier;

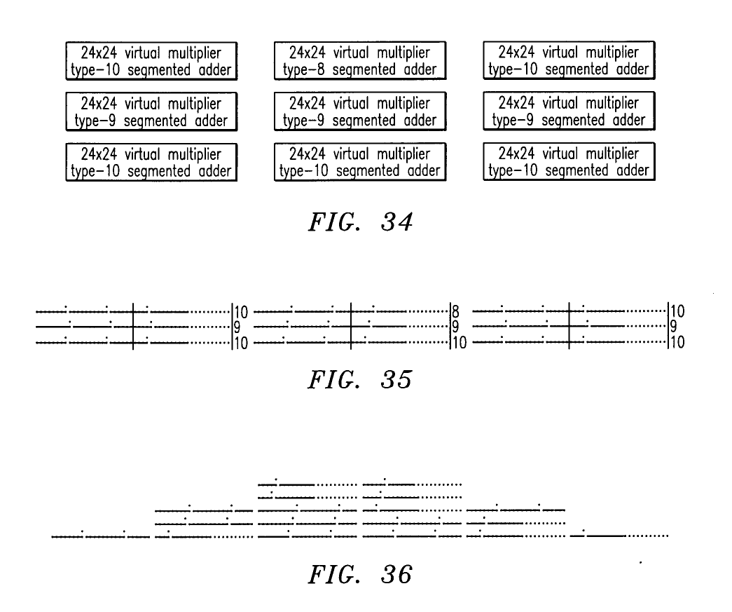

FIGS. 33 to 36 show a 72×72 multiplier; and

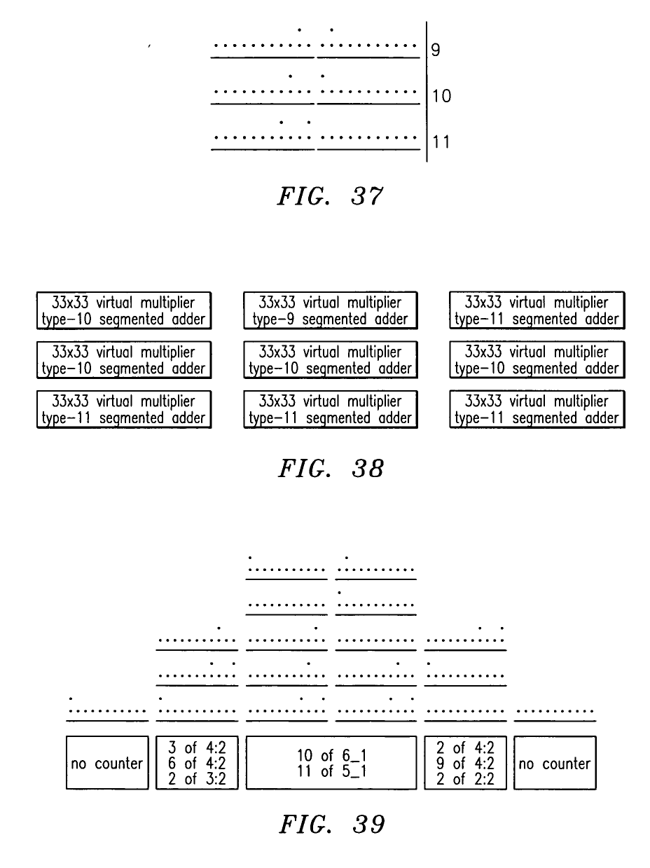

FIGS. 37 to 39 show a 99×99 multiplier.

(4) Borrow parallel counters for 2's complement multipliers

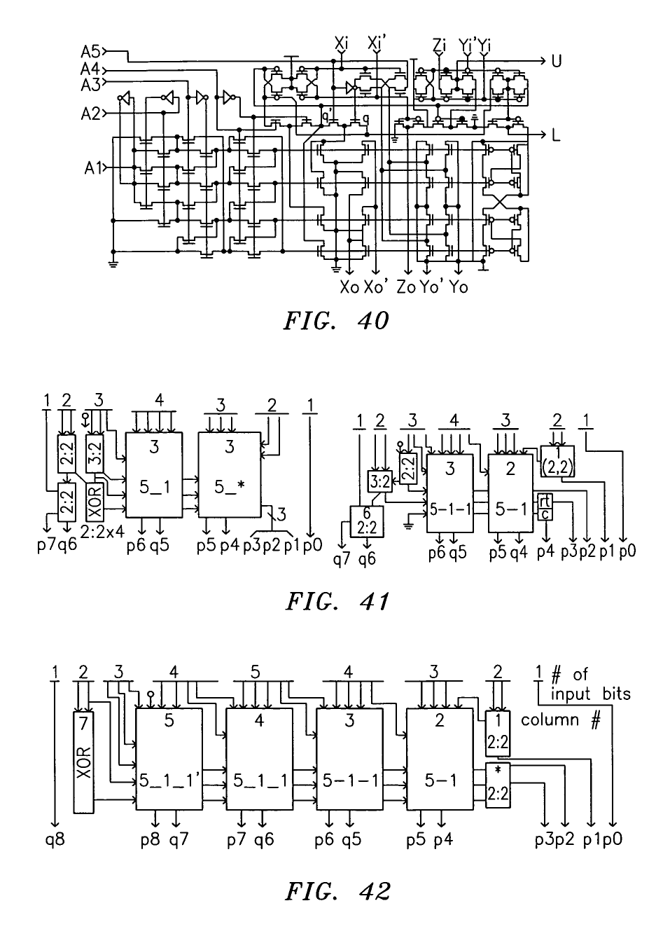

FIG. 40 illustrates a modified 5_1 borrow parallel counter denoted by 5_1′, which is the same as a regular 5_1 counter except that its input includes a hidden 1, i.e. it implements 1+A1+A2+A3+A4+2A5+2Xi+4(Yi+2Yi′Zi)=Xo+2Yo+4(Yo′Zo+L)+8U; (and Zo=Xi). Since a 6_0 is synthesized by a 5_1 counter and a 3:2 counter, the 6_0′ and 7_0′ counters can be constructed by a 5_1′ counter with a 3:2 and a 5_1′ counter with two 3:2 counters respectively.

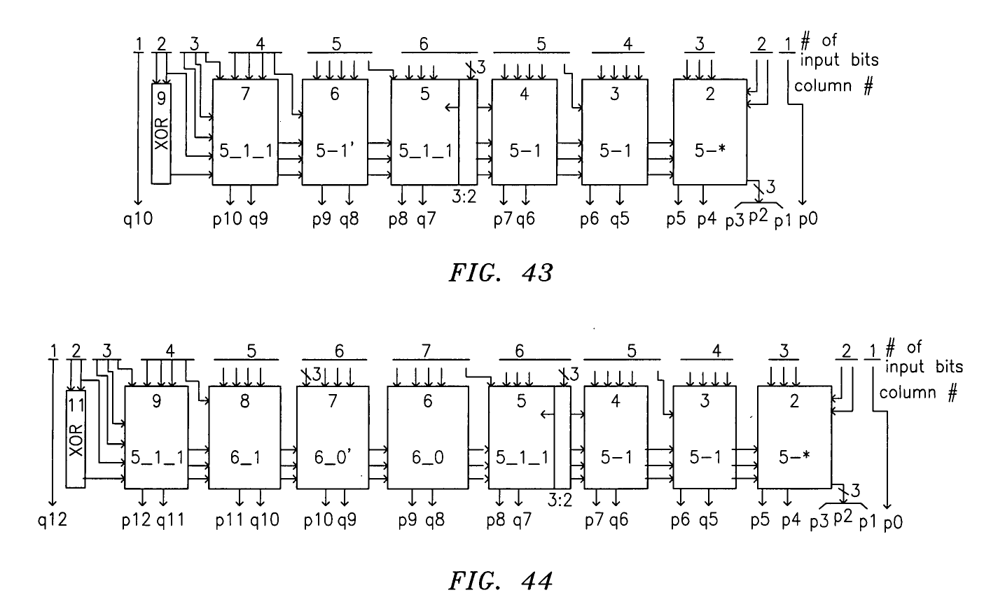

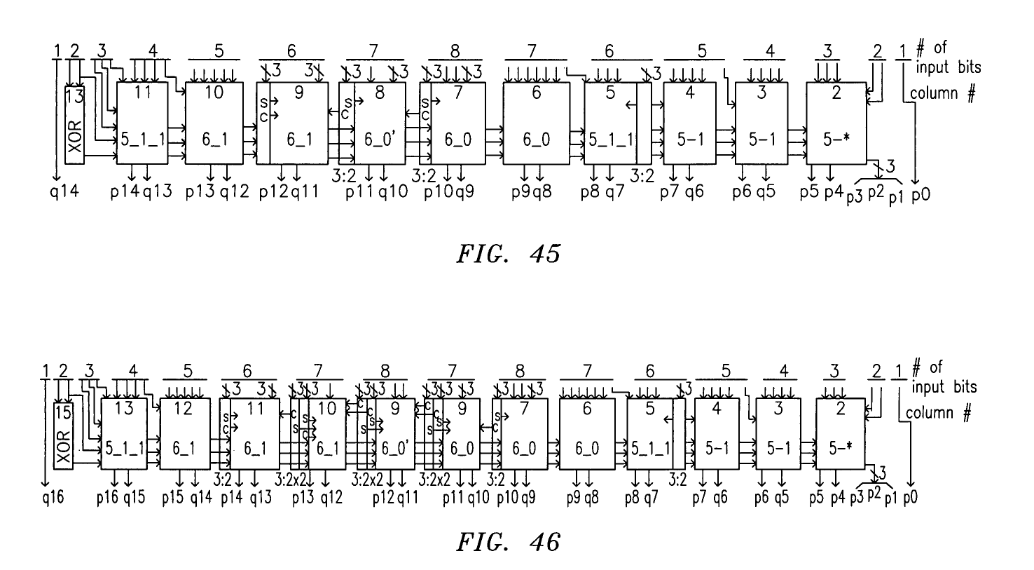

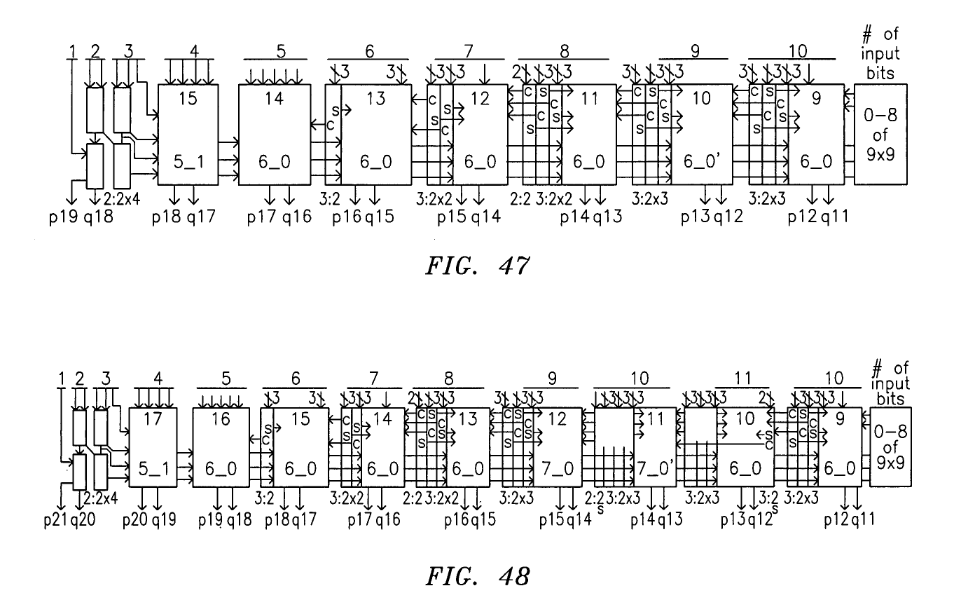

Modified small multipliers 4-b to 11-b from NxN-b multipliers for n between 4 to 11 are shown in FIGS. 41 to 48 to 2's complement NxN multipliers.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A base multiplier circuit for multiplying an NxN binary word, comprising:
an array of borrow parallel counters for processing at least part of an input bit pattern according to a predetermined formula;
at least one x:2 counter coupled to at least one of the borrow parallel counters, the x:2 counter for pre-reducing a number of input bits and providing late arrival signals without increasing total delay; and
an adder coupled to an output of at least one of the borrow parallel counters, the adder for summing the output of the at least one borrow parallel counter.

2. The base multiplier circuit of claim 1, wherein the borrow parallel counters are chosen from one of a 5_0, 5_1_1, 6_0, 6_0′, 6_1, 7_0 and 7_0′ borrow parallel counter.

3. The base multiplier circuit of claim 1, wherein a weighted sum of all inputs to each respective borrow parallel counter is equal to the weighted sum of all outputs of the respective borrow parallel counter.

4. The base multiplier circuit of claim 1, wherein at least one of the borrow parallel counters is a 5_0 borrow counter having the weighted sum of inputs to the outputs defined by
A1+A2+A3+A4+2A5+2Xi+4(Yi+2Yi′Zi)=Xo+2Yo+4(Yo′Zo+L)+8U,
where A₁-A₅ are inputs, U and L are outputs, and Xi, Yi, Zi are in-stage input bits, Xo, Yo and Zo are in-stage output bits, Yo′ and Yi′ are the complements of Yo and Yi, respectively, and Zo=Xi.

5. The base multiplier circuit of claim 5, wherein at least one of the borrow parallel counters is a 5_1_1 borrow parallel counter having a weighted sum of the inputs to the outputs defined by
A1+A2+A3+2A4+2A5+2Xi+4(Yi+2Yi′Zi)=Xo+2Yo+4(Yo′Zo+L)+8U,
where, A₁-A₅ are inputs, U and L are outputs, and Xi, Yi, and Zi are in-stage input bits and Xo, Yo, and Zo are in-stage output bits, Yo′ and Yi′ are the complements of Yo and Yi, respectively, and Zo=Xi.

6. The base multiplier circuit of claim 1, wherein at least one of said borrow parallel counters is a 5_1′ borrow parallel counter having a weighted sum of the inputs to the outputs defined by
1+A1+A2+A3+A4+2A5+2Xi+4(Yi+2Yi′Zi)=Xo+2Yo+4(Yo′Zo+L)+8U,
where A₁-A₅ are inputs, U and L are outputs, Xi, Yi, and Zi are in-stage input bits and Xo, Yo, and Zo are in-stage output bits, Yo′ and Yi′ are the complements of Yo and Yi, respectively, and Zo=Xi.

7. The base multiplier circuit of claim 1, wherein the counters include “4-bit 1-hot” logic processing.

8. The base multiplier circuit of claim 1, wherein the adder is one of a ripple-carry adder or a single-level carry-look-ahead adder

9. The base multiplier circuit of claim 1, wherein the x:2 counter is chosen from one of a 2:2, 3:2, 3:2N and 3:2NL counter.

10. A method for multiplying a binary input bit pattern, said method comprising:
inputting at least part of the input bit pattern into an array of borrow parallel counters and processing the at least part of the input bit pattern according to a predetermined formula;
inputting at least part of the input bit pattern into at least one 3:2 counter which is coupled to at least one of the borrow parallel counters, the 3:2 counter for pre-reducing number of input bits and providing late arrival signals without increasing total delay;
summing, using an adder, an output of at least one of the borrow parallel counters to determine a product; and
outputting the product from said adder.

11. The method according to claim 10, wherein the borrow parallel counters are chosen from one of a 5_0, 5_1_1, 6_0, 6_0′, 6_1, 7_0 and 7_0′ borrow parallel counters.

12. The method according to claim 10, wherein a weighted sum of all inputs to each respective borrow parallel counter is equal to the weighted sum of all outputs of the respective borrow parallel counter.

13. The method according to claim 10, wherein at least one of the borrow parallel counters is a 5_0 borrow counter having the weighted sum of inputs to the outputs defined by
A1+A2+A3+A4+2A5+2 Xi+4(Yi+2Yi′Zi)=Xo+2Yo+4(Yo′Zo+L)+8U,
where A-A₅ are inputs, U and L are outputs, Xi, Yi, and Zi are in-stage input bits, Xo,
Yo, and Zo are in-stage output bits, Yo′ and Yi′ are the complements of Yo and Yi, respectively, and Zo=Xi.

14. The method according to claim 10, wherein at least one of the borrow parallel counters is a 5_1_1 borrow parallel counter having a weighted sum of the inputs to the outputs defined by
A1+A2+A3+2A4+2A5+2Xi+4(Yi+2Yi′Zi)=Xo+2Yo+4(Yo′Zo+L)+8U,
where, A₁-A₅ are inputs, U and L are outputs, Xi, Yi, and Zi are in-stage input bits, Xo, Yo, and Zo are in-stage output bits, Yo′ and Yi′ are the complements of Yo and Yi, respectively, and Zo=Xi.

15. The method according to claim 10, wherein at least one of said borrow parallel counters is a 5_1′ borrow parallel counter having a weighted sum of inputs to the outputs defined by
1+A1+A2+A3+A4+2A5+2Xi+4(Yi+2Yi′Zi)=Xo+2Yo+4(Yo′Zo+L)+8U,
where A₁-A₅ are inputs, U and L are outputs, Xi, Yi, and Zi are in-stage input bits, Xo, Yo, and Zo are in-stage output bits, Yo′ and Yi′ are the complements of Yo and Yi, respectively, and Zo=Xi.

16. The according to claim 10, wherein the borrow parallel counters include “4-bit 1-hot” logic processing.

17. The method according to claim 10, wherein the adder is a one of ripple-carry adder or a single-level carry-look-ahead adder.

18. An NxN multiplier circuit, comprising:
a plurality of base multipliers, each base multiplier receiving a trisected input stream and generating a virtual product;
an array of x:2 counters for receiving each of the virtual products from each of
the base multipliers and outputting a result.

19. The multiplier circuit of claim 18, wherein each of the base multipliers comprises an array of borrow parallel counters for processing at least part of an input bit pattern according to a predetermined formula.

20. The multiplier circuit of claim 19, wherein at least one x:2 counter is coupled to at least one of the borrow parallel counters, the x:2 counter pre-reducing number of input bits.

21. The multiplier circuit of claim 20, further comprising an adder coupled to an output of at least one of the borrow parallel counters, the adder summing the output of the at least one borrow parallel adder and producing the virtual product.

22. The multiplier circuit of claim 18, wherein the base multipliers are arranged side by side with each other and form a square matrix.

23. The multiplier circuit of claim 18, wherein bits contained within the virtual product are shifted in a predetermined pattern prior summing by at least one of the x:2 counters.

24. The multiplier circuit of claim 18, wherein bits contained within at least one virtual product are shifted before the corresponding virtual product is summed by at least one of the array of x:2 counters.

25. The base multiplier circuit of claim 18, wherein the borrow parallel counters include “4-bit 1-hot” logic processing.
